(19) United States
(12) Patent Application Publication
(10) Pub. No.: US 2013/0091221 A1
(43) Pub. Date: Apr. 11, 2013

(54) COEXISTENCE OF SOCIAL NETWORKS

(71) Applicant: Broadcom Corporation, Irvine, CA (US)

(72) Inventor: James D. Bennett, Hroznetin (CZ)

(73) Assignee: BROADCOM CORPORATION, Irvine, CA (US)

(21) Appl. No.: 13/628,792

(22) Filed: Sep. 27, 2012

Related U.S. Application Data
(60) Provisional application No. 61/545,147, filed on Oct. 8, 2011.

(51) Int. Cl. G06F 15/16

(52) U.S. Cl. 709/204

(57) ABSTRACT

Real time bridging mechanisms and a proprietary or industry standard interface used to extend social network (SNET) operations between two or more SNETs. In one embodiment, a user may join one social network, a second user may join a different social network, and the two may coexist on an interface used by one of the social networks. Some or all of the functionality of a given SNET may be mapped. With robust coexistence, a member of one SNET may invite and fully interact with a member of another SNET (wherein members may be a human, device, software or service) as if they were members of the same SNET. In further embodiments, a user or social device might have established social information (postings, personal information, etc.) and profiling information (social information and content, docked device information, social network linkage, etc.) that may be reused or cloned across a SNET group.

### CROSS REFERENCE TO RELATED PATENTS/PATENT APPLICATIONS

### Provisional Priority Claim

The present U.S. Utility patent application claims priority pursuant to 35 U.S.C. §119(e) to the following U.S. Provisional patent application which is hereby incorporated herein by reference in its entirety and made part of the present U.S. Utility patent application for all purposes:

1. U.S. Provisional Patent Application Ser. No. 61/545,147, entitled “Social Network Device Memberships and Resource Allocation,” (Attorney Docket No. BP23771), filed Oct. 8, 2011, pending.

### BACKGROUND OF THE INVENTION

1. Technical Field of the Invention

The invention relates generally to social networking; and, more particularly, it relates to social network memberships, including coexistence and interaction between members of social networks.

2. Description of Related Art

The popularity and growth of social network sites and services has increased dramatically over the last few years. Present social network sites include Facebook, Google+, Twitter, MySpace, YouTube, LinkedIn, Flicker, Jaiku, MYUBO, Bebo and the like. Such social networking (SNET) sites are typically web-based and organized around user profiles and/or collections of content accessible by members of the network. Membership in such social networks is comprised of individuals, or groupings of individuals, who are generally represented by profile pages and permitted to interact as determined by a particular social networking service.

Social network members often share a common bond, social status, or geographic or cultural connection with their respective contacts. In many popular social networks, especially profile-focused social networks, activity centers on web pages or social spaces that enable members to view profiles, communicate and share activities, interests, opinions, status updates, audio/video content, etc., across networks of contacts. Social networking services might also allow members to track certain activities of other members of the social network, collaborate, locate and connect with existing friends, former acquaintances and colleagues, and establish new connections with other members. Individual members typically connect to social networking services through existing web-based platforms via a computing device, tablet or smartphone.

In so-called “cloud” computing, computing tasks are performed on remote computers/servers which are typically accessed via Internet connections. One benefit of cloud computing is that may reduce the relative processing and storage capabilities required by user devices (e.g., a cloud computer may load a webpage accessed by a tablet device and communicate only required information back to the tablet). Accordingly, recent years have witnessed an ever-growing amount of content and application software being migrated from local or on-site storage to cloud-based data storage and management. Such software functionality/services and content are typically available on-demand via (virtualized) network infrastructures.

### BRIEF DESCRIPTION OF THE SEVERAL VIEWS OF THE DRAWINGS

FIG. 1 illustrates various embodiments of social network bridging in accordance with the disclosure.

FIG. 2 illustrates various embodiments of social network formation and management in accordance with the present disclosure.

FIG. 3 illustrates an exemplary service provider social network hosting system in accordance with an embodiment of the disclosure.

FIG. 4 illustrates social network group spawning and dismantling in accordance with an embodiment of the disclosure.

FIG. 5 illustrates a social network media sharing group in accordance with an embodiment of the disclosure.

FIG. 6 is a logic diagram of a method for extending capabilities of first social network group to a member of a second social network in accordance with an embodiment of the present disclosure.

FIG. 7 is a logic diagram of a method for establishing associations between a social network group and a human or social device having established profile information in accordance with an embodiment of the disclosure.

FIG. 8 is a logic diagram of a method for spawning a social network group in accordance with an embodiment of the present disclosure.

FIG. 9 is a schematic block diagram of a social networking grouping hierarchy according to various embodiments of the disclosure.

FIG. 10 is a schematic block diagram of an embodiment of a social device comprising integral functionality operable to support social network group/sub-group membership and communications in accordance with the disclosure.

### DETAILED DESCRIPTION OF THE INVENTION

As used herein, the terms “social network” and “SNET” comprise a grouping or social structure of devices and/or individuals, as well as connections, links and interdependencies between such devices and/or individuals. Members or actors (including devices) within or affiliated with a SNET may be referred to herein as “nodes”, “social devices”, “SNET members”, “SNET devices”, “user devices” and/or “modules”. In addition, the terms “SNET circle”, “SNET sub-circle”, “SNET group” and “SNET sub-group” generally denote a social network that comprises social devices and, as contextually appropriate, human SNET members and personal area networks (“PANs”).

As used herein, the term “resource” is intended to encompass at least content, which can include of one or more types of content, including, without restriction, audio content, video content, graphics, and text, and capabilities provided via various SNET members, services, applications, and associated devices. Interaction with resources can include accessing resources and providing resources. A processing system can include, without limitation, one or more instances of processing circuitry distributed across one or more server devices, network nodes, some combination thereof, or the like.

As noted, there are many different types of SNETs offering a variety of services. By way of example, SNETs may offer services tailored for: enterprises; business-to-business interactions; professional contacts; friends and family; gaming; dating; children; music; sports; etc. Within each category of such SNETs, there may be many competitors. A given individual may desire to join only one social network, while others may want to join many social networks. However, if two people wish to interact in certain ways, they may both need to both join a common SNET. As a result, many are either forced to migrate to a single common SNET or maintain multiple SNET memberships in order to gain access to specific cohorts or services.

In accordance with various embodiments of the disclosure, real time bridging mechanisms (for example, a proprietary or industry standard API interface) can be used to extend SNET operations between two or more SNETs. In this manner, for example, a user may join one social network, a second user may join a different social network, and the two may coexist on an interface used by one of the social networks. Some or all of the resources and capabilities of a given SNET may be mapped. It is noted that, with robust coexistence, a member of one SNET could invite and fully interact with a member of another SNET (wherein members may be a human, device, software or service) as if they were members of the same SNET.

In a further embodiment of the present disclosure, a user or social device might have established social information (postings, personal information, etc.) and profiling information (social information and content, docked device information, social network linkage, etc.). Such information can be reused or cloned across a SNET/group in accordance with various embodiments of the disclosure.

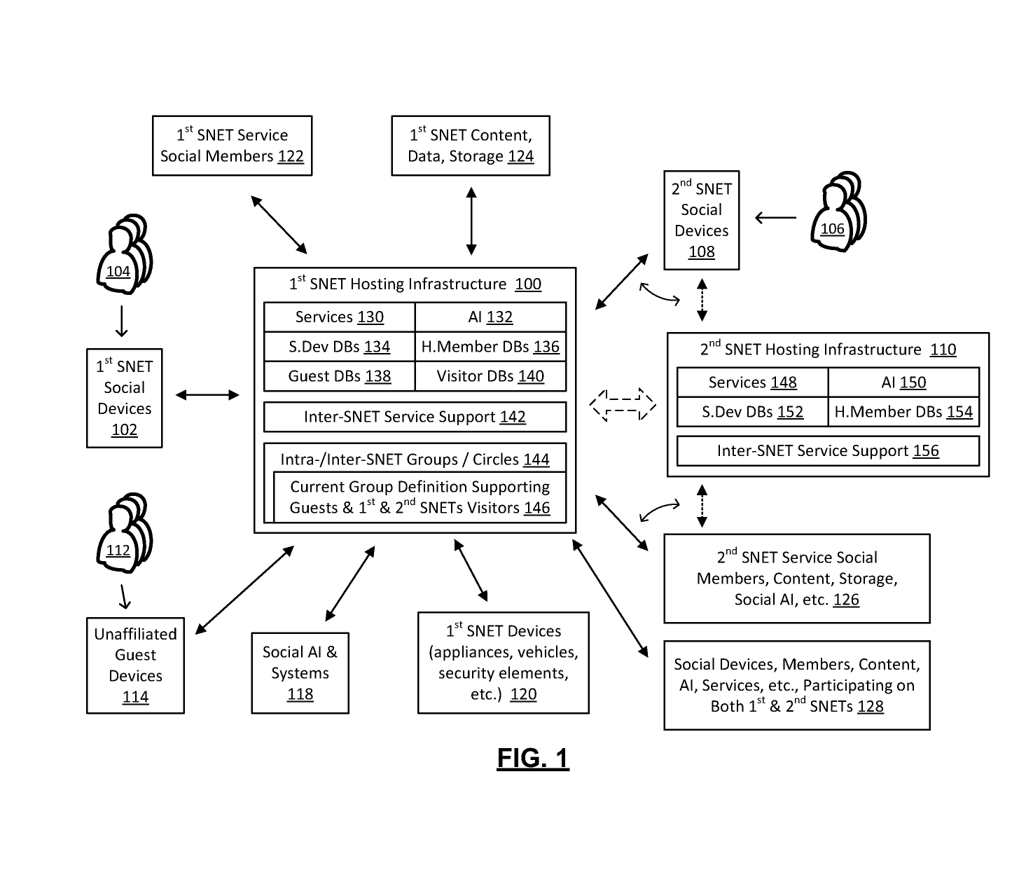

Referring more specifically to FIG. 1, various embodiments of social network bridging in accordance with the disclosure are shown. A first social network (“SNET”) hosting infrastructure 100 is configured to support interaction between members of distinct SNETs or SNET groups including, for example, interaction between members of SNETs hosted or supported by the first SNET hosting infrastructure 100 and a second SNET hosting infrastructure 110. The illustrated SNET hosting infrastructure 100 may provide a wide variety of services and membership support functions for one or more SNET groups (or circles), including SNET groups comprised of both intra- and inter-SNET members.

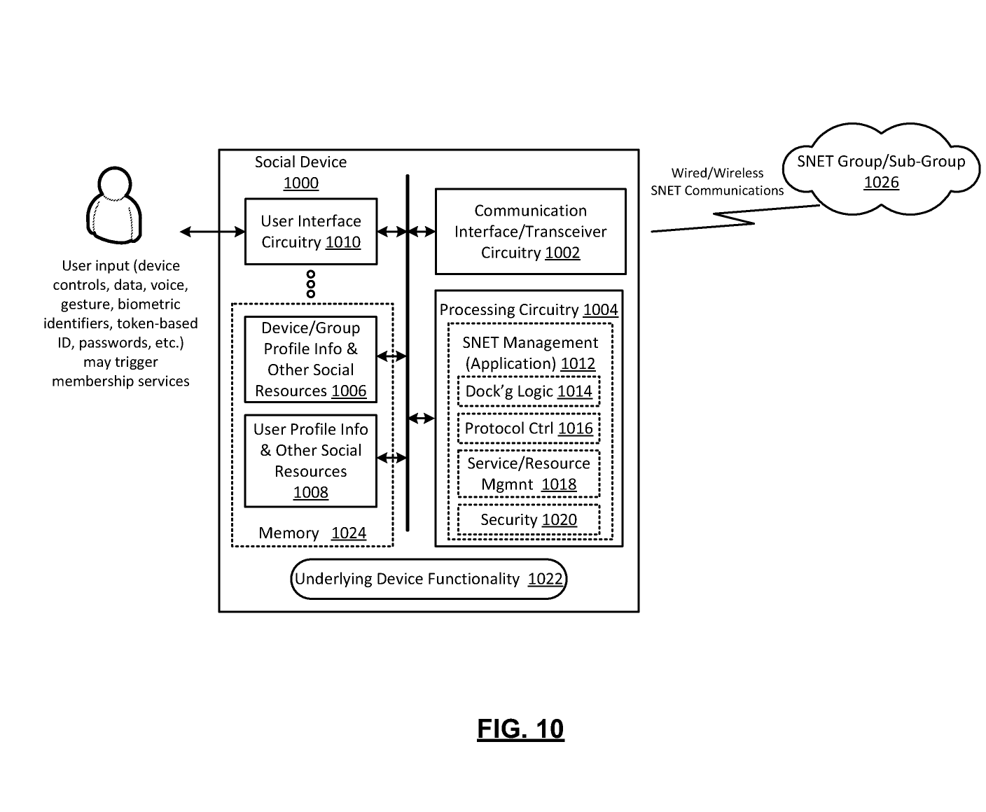

In the illustrated embodiment, membership in a SNET group supported by the SNET hosting infrastructure 100 includes human members 104 interacting through first SNET social devices 102 (embodiments of which are described in conjunction with FIG. 10). Likewise, human members 106 of a SNET group supported by the SNET hosting infrastructure 110 may interact with an inter-SNET group (as described below) through second SNET social devices 108. Other humans 112, whether a member of an intra-/inter-SNET group or an unaffiliated guest, may interact through unaffiliated guest devices 114.

As will be appreciated, each human member may have a respective personal SNET sub-group of associated or docked social devices capable of independent or aggregated participation in the SNET group. The SNET sub-group may be locally or remotely accessible by a human member and/or other SNET group/sub-group members through various means, such as clicking on an icon or exchanging an identification handle associated with the human member/personal sub-group. Personal sub-groups may be persistent or of limited duration, and include ad hoc and/or static associations. Further, access to a SNET group by a human can be established through an authorized SNET account or profile information associated with the human and/or personal devices.

SNET nodes in the illustrated embodiment further include social artificial intelligence (AI) agents and social systems 118, which may or may not be members of a supported SNET group. Social AI agents can take many forms including, by way of example, personal avatars, digital assistants and robotic control functions. Social system 118 may include one or more local or remote servers and (distributed) server clusters or server farms that provide a support infrastructure/supporting system for SNET group functionality and member operations such as routing, data storage, social services, docking and management services, etc.

In certain embodiments, formation, maintenance and operation of a SNET group can be performed by standalone or distributed SNET processing circuitry and software. It is noted that “SNET processing circuitry” may comprise hardware, software, applications, or various combinations thereof, and be configurable to support various functionalities disclosed herein. Further, SNET processing circuitry may be included in a (social or non-social) standalone server, server farm, cloud-based resources, and/or the various types of devices described below, and incorporate authentication and security functionality. In addition, specialized middleware may also be utilized by SNETs according to the disclosure, including standardized middleware and/or standardized communication protocols having an associated certification process.

Membership in a SNET group supported by the SNET hosting infrastructure 100 can further include first SNET devices 120 configured to operate within a SNET group. Exemplary SNET devices 120 may be broadly categorized as either (i) social devices that include a user or SNET group interface sufficient to provide meaningful input to SNET interaction and (ii) social devices that support minimal or no user input relevant to SNET interaction. More particularly and without limitation, the first category may include computers, tablet devices, IPTVs, IPTV set top boxes, smart phones, servers, laptops, cloudbooks, network attached storage devices, gaming consoles, media players/sources, communication nodes (access points, routers, switches, gateways, etc.), user interface devices, power line communication (PLC) devices, etc. Such social devices may receive user input for SNET setup and management. The second category may include, again without limitation, certain appliances and vehicles, printers, projectors, cameras and camcorders, scanners, speakers, headsets, smoke detectors, alarm systems, video cameras, mice, etc. In general, dockable social devices include any electronic device that could be operably coupled to or docked in a SNET group/sub-group via wired or wireless pathways to participate as a SNET member.

Social functionality in such devices can be implemented through various means. For example, a device may have integral hardware/firmware/software to support SNET access and member operations. Alternatively, a general purpose or legacy device may include social code or applications that enable participation in a SNET. In a further embodiment, a device designed to include social functionality may participate in a SNET through a combination of non-social code and a social shim layer or driver wrapper. In yet another embodiment, a member device having a social design may utilize additional social code, including code specific to a SNET group. Similarly, social services according to various embodiments may leverage legacy services. Depending on the nature of a social device wishing to engage with a particular SNET, and as necessary, management functionality of a SNET or SNET hosting system could direct or trigger installation of appropriate application software and underlying drivers in the social device. Such operations might be performed with minimal involvement from inherent functions of the social device.

The SNET hosting infrastructure 100 may offer a wide variety of fixed and intelligent member services participating as first SNET service social members 122, including both internal and external services accessible by SNET members. By way of example, the SNET hosting infrastructure 100 may offer payment processing services, storage and backup services, and other services between full members and/or authorized guest members and visitors. In certain embodiments, SNET service social member 122 may themselves participate or be selectable to participate as members of one or more intra-/inter-SNET groups. As with other resources of the SNET hosting infrastructure 100, such as first SNET content, data, and storage 124, access control and constraints on SNET service social members 122 may be applied to individual SNET members or classes of members.

As used herein, the term “resources” or “social resources” encompasses both device level and network infrastructure level (cloud/server) devices, services, software and other functionality, and can include SNET group multicasting functionality, transcoding, one or more instances of media and other content, content storage/caching/servers, media capture elements (microphones, cameras, mechanical mounting controls), profile information, services and applications provided by SNET infrastructure, capabilities provided by various other users and docked devices, and the like. SNET users can interact with resources via one or more devices supporting the users, as shown in FIG. 1.

Communications between the various devices, resources and SNET infrastructures of FIG. 1 may occur over one or more wired and wireless communication networks. Further, communications within a particular SNET group, as well as communications with nonmembers, may occur via dedicated or multifunction communication path devices. Depending on the configuration of a particular SNET group, access to certain social resources and devices may occur in a direct or peer-to-peer manner, while a client/server flow is used elsewhere in the SNET group. Access to the SNET group can also be provided by a proxy server that functions as an intermediary for access requests from proxy clients—including social devices connected to the proxy server via the Internet or other IP-based networks—seeking to communicate with members and resources of a SNET group. The proxy server may be a distributed or cloud-based entity, or a member of (or incorporated in a member of) the SNET group.

In addition to the foregoing, other entities in SNET resources affiliated with the second SNET hosting infrastructure 110 may further interact with the first SNET hosting infrastructure 100. For example, second SNET service social members, content, storage, social AI, etc. 126 may participate as members or functionally coexist with one or more SNET groups of the first SNET hosting infrastructure 100 in accordance with various bridging and mapping mechanisms described herein. Likewise, social devices, members, content, social AI, services, etc. 126 may participate on SNETs of both the first and second hosting infrastructures 100 and 110. In various embodiments, participation between SNETs may be identical, or involve differing capabilities and functions (including subsets thereof) depending on a particular SNET. Such differences may be determined, for example, based upon a particular identification handle used to join or interact with a given SNET or SNET group.

Referring more specifically to the first SNET hosting infrastructure 100, various resources such as services 130 (or listings of and links to available services) and AI capabilities 132 are provided to support members of one or more SNET groups. Certain AI capabilities 132 may include, for example, a “persona” or human interface, and may be capable of independently controlling social devices and other components or members of a SNET group.

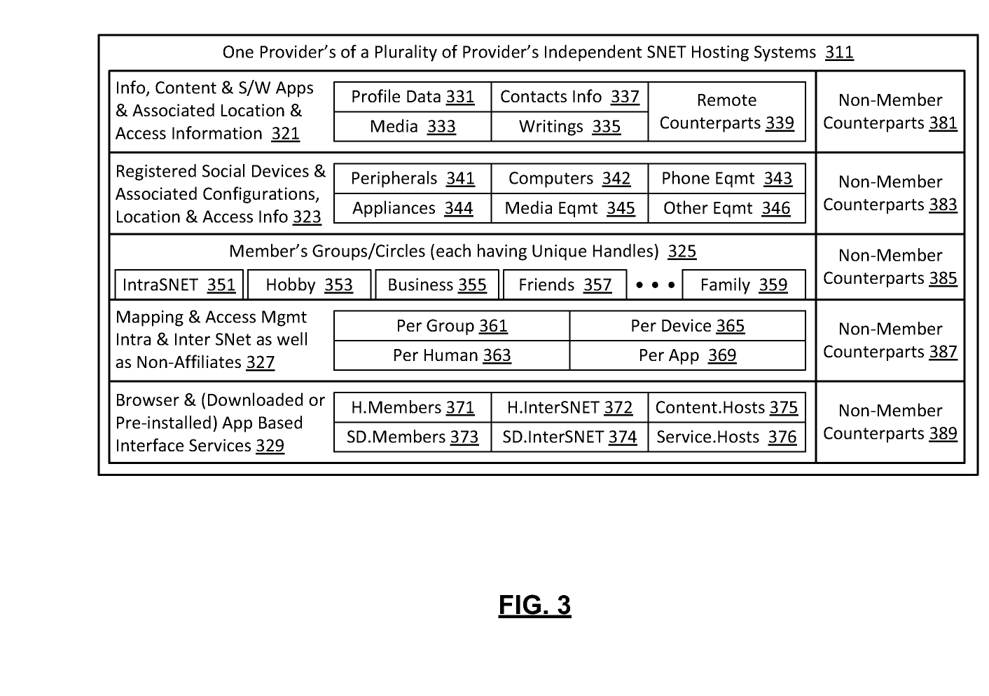

In order to support real time bridging mechanisms extend SNET operations between two or more SNETs, the first SNET hosting infrastructure 100 may further maintain various databases relating to members and prospective members, guests or visitors. These databases include a social device databases 134, human member databases 136, guest databases 138 and visitor databases 140. Exemplary content for these databases is more fully in conjunction with the Figures that follow, including FIG. 3. Briefly, such databases may comprise listings or indications of: affiliated registered social devices/resources and associated location and access information; access rights; SNET and SNET group memberships; accessible and controlled social resources and content; location-based information; device owner and model information; as well as other profile information. In the illustrated embodiment, second SNET hosting infrastructure 110 supports similar services 148 and AI capabilities 150, as well as social device databases 152, human member databases 154, etc.

In the illustrated embodiment, functional coexistence between SNET members supported by the first SNET hosting infrastructure 100 and one or more members of a second SNET hosted by the second SNET hosting infrastructure 110 is facilitated by inter-SNET service support 142. In particular, inter-SNET service support 142 may perform various bridging and mapping operations that extend features and functions (e.g., mail or other communication services) of one SNET to members of a second SNET. In one embodiment, inter-SNET service support 142 provides a common user interface through which members of different SNETs may coexist and interact. Corresponding inter-SNET service support 156 is provided by the second SNET hosting infrastructure 110.

The first SNET hosting infrastructure 100 may support one or more intra-/inter-SNET groups/circles 144 (“SNET groups 144”) that may be comprised of various combinations of human members, services, devices, and other resources as described above. Although not separately illustrated, the second SNET hosting infrastructure 110 similarly supports one or more SNETs/SNET groups. Formation of SNET groups 144, as well as interactions between members and non-members, may be accomplished in a variety of ways in accordance with the present disclosure. In the illustrated embodiment, a current SNET group definition 146 is provided to support interactions between a first SNET group and guests and visiting members of the first and second SNET hosting infrastructures 100 and 110.

The SNET group definition 146 in certain embodiments may govern treatment of supported guest and visiting devices that fall into different categories depending on the type of device and its social capabilities. Without limitation, devices may be: legacy devices that might rely on browser-based operations or downloaded applications or plugins for interaction; social devices with inherent social capabilities to support interaction with a SNET group; social devices running unaffiliated social code; devices that support human interaction; devices that do not require human interaction for participation; devices that are already configured as a member of a particular SNET group(s); devices associated with a particular SNET member; devices having a particular model number; devices that are clients of a particular server or type of server; etc. For example, a social camera might be tethered to a (non-social) personal computer that in turn communicates with the first SNET hosting infrastructure 100, the social camera providing an identification handle that is included in the SNET group definition 146 for purposes of accessing a media stream generated by the camera. In another example, a tablet device without inherent social capabilities may execute an installed application that effectively offers social capabilities to a user.

Access to and visibility of resources of a social group, such as services 130 and artificial intelligence capabilities 132, may be managed through general and member class-specific access configurations. For example, if membership in a SNET group 144 includes family members and associated devices, a uniform access configuration (or separate device and human configurations) could be applied across the class in an automatic or automated manner. In other embodiments, access control and constraints are imposed on a per-member or per-guest basis.

Participation in a SNET group 144 can also be supported through functionality that includes automated and member-triggered membership (or guest/visitor) invitations. More particularly, and without limitation, inter-SNET service support 142 may function to invite prospective members to participate in the SNET group 144 through automatic, automated and member-triggered processes. For example, a human member of SNET group 144 might establish a SNET group definition that supports creation of a SNET group 144 by automatically inviting/accepting members having certain characteristics (such as devices owned or controlled by a particular member or acquaintances of the member). Processing of accepted invitations and unsolicited requests to join the SNET group 144 may be conditioned upon input or authorization from an existing member(s) or human user(s) (e.g., through a user interface). Invitations to interact might be filtered through a directory service or cloud-based registrar that assists in identifying bridging opportunities and compatible functionality based on (broadcast/registered/dynamic) accessible SNET member profiling information and advertised SNET server configurations. In further embodiments, invitations to interact might be based on member searching operations (such as searching of a contact list), friends of friends, etc.

Identity handles for individual members and groups of members, as well as SNET groups, may be used for various purposes and exchanged in a variety of ways. For example, textual handles could be communicated directly from one device to another (with or without a password requirement), or through SNET hosting systems configured to facilitate communications with unaffiliated third parties. Such communications might flow through security functionality provided by a SNET hosting system, a SNET security node, security features integral to one or more social devices, etc. Through the exchange of an identity handle and like profile information, a user or device may become a member of a particular SNET group, or be enabled to interact with a SNET group through, for example, a common user interface. Default or specified levels of access may be set by one or more the interacting entities.

In various embodiments, a given SNET or SNET group may be configured to provide a specified level of access to visitors or guest members that provide specific identification information or handles. For example, a first member or group of members of one SNET group might desire to interact with members of a distinct, business-related SNET group utilizing or identified by a “g.xxx.bus” handle. By providing a handle such as “g.bennett.bus”, the first member may gain access to the SNET group through a common user interface or inter-SNET service support functions. In other embodiments, SNET processing circuitry or management functionality may generate a code handle (e.g., a 40 digit alphanumeric code) relating to a request to interact with an established SNET group and/or profile information associated with such a request. The code handle could be received and entered, for example, into a social device which is thereby authorized to interact with the SNET group. Such interaction may occur through devices already attached to the SNET group, or through devices that gain access through the authorization process.

As will be appreciated, interactions between members of distinct SNETs or SNET groups may take many forms and may depend, at least in part, on bridging operations between particular SNETs. Such bridging operations, as well as general relationships between SNETs, may be static or dynamic over time. For example, if a first SNET service provider having a first membership acquires or enters into a strategic relationship with a second, competing SNET service provider having a distinct membership, the first SNET service provider may establish functional associations and relationships between the two memberships that permit robust coexistence without requiring the members to join a new SNET. Such coexistence might entail shared/cloned database elements or parallel, real time updates to database elements, comprehensive searching functions, etc. Conversely, if functional associations and member interactions between first and second SNETs are terminated (e.g., the large arrow of FIG. 1 disappears), a member of the first SNET might still be able to interact with the membership of a second SNET, but only in reduced capacity or in a similar manner to a guest, and possibly through alternate communication pathways.

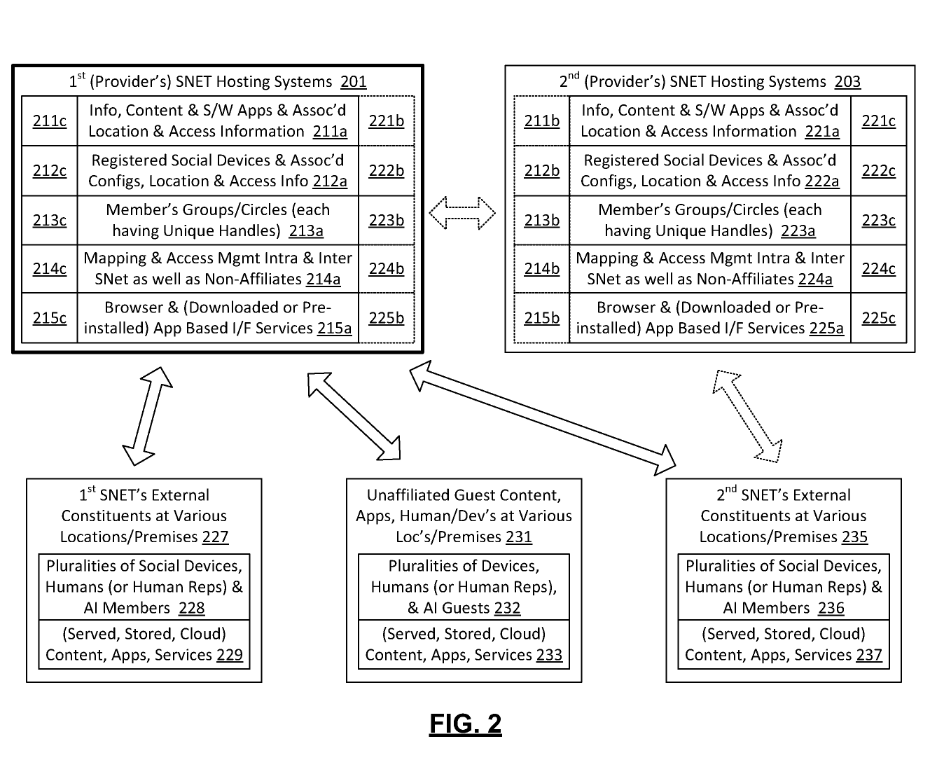

Referring now to FIG. 2, various embodiments of social network formation and management in accordance with the present disclosure are illustrated. In particular, SNET capabilities of a SNET hosting system 201 of a first provider are shown interacting with a SNET hosting system 203 of a second provider, as well as various external and unaffiliated constituents. The illustrated SNET hosting system 201 hosts or supports databases and content associated with one or more members of a first SNET or SNET group, as well as mapping, access and interface services. Details regarding exemplary components of each of the elements 211a-215a (as well as corresponding elements 221a-225a) are described more fully in conjunction with FIG. 3. In the illustrated embodiment, it is noted that elements 211b-215b and 221b-225b represent pointers to or copies/proxies of relevant portions of corresponding elements 211a-215a and 221a-225a, respectively, while elements 211c-215c and 221c-225c indicate corresponding elements used for interactions with guest entities.

More particularly, databases and resources supported by the SNET hosting system 201 include information, content and software applications, as well as associated location and access information 211a; registered social devices and associated configurations, location and access information 212a; member's SNET groups/circles 213a (each having unique handles); and mapping and access management 214a supporting intra- and inter-SNET operations, as well as operations involving non-affiliates. SNET hosting system 201 further supports browser and application based interface services 215a to support, for example, coexistence between members of different SNET groups. Corresponding databases and resources are supported by the second SNET hosting system 203 as illustrated by elements 221a-225a.

In addition to the foregoing, a SNET supported by the SNET hosting system 201 may comprise external constituents 227 at various locations or premises. These external constituents may comprise, for example, pluralities of social devices, humans (or representatives of humans) and AI members 228, and content, applications, and services 229 that may be served or stored externally (including cloud-based applications and storage). A SNET supported by the SNET hosting system 203 may comprise similar external constituents 235 at various location or premises, including pluralities of social devices, humans (or representatives of humans) and AI members 236, and content, applications, and services 237. In certain applications, such external constituents 235 may interact with or be accessible to the SNET hosting system 201, either directly or via the SNET hosting system 203 or other unaffiliated constituents. The SNET hosting system 201 of the illustrated embodiments may further interact with unaffiliated guest content, applications, humans and/or devices 231 at various locations or premises including, for example, pluralities of social devices, humans (or representatives of humans) and AI guests 232, and content, applications, and services 232.

With general reference to the elements of FIG. 2, a wide variety of operations may be performed to establish SNET group and inter-SNET group interactions. For example, a human member of a SNET hosted by SNET hosting system 201 may wish to establish a SNET group 213a comprised, at least in part, of a selection of registered social devices 212a. Device selection might be performed by dragging icons representing desired devices into a graphical representation of the SNET group. Further, other SNET group participants might be selected (e.g., based on icons) from amongst human participants in external SNETs, unaffiliated guests, local and external services, etc. In some embodiments, selected humans and devices themselves may be enabled to further select additional humans or social devices for participation in the SNET group (possibly with a right of first refusal by the originator of the group).

Mapping and access management functions may be employed to create a specialized configuration for the SNET group including, for example, a group handle or password, access rights for different classes of participants, etc. In addition, acceptance of an identification handle for docking in the new SNET group may further dock social devices associated the handle. The originating member's own affiliated devices may be automatically or selectively included in the SNET group. External devices may then be able to interact with the member's devices via a common interface. The originating human member might also establish one or more additional SNET groups, including sub-groups of an established group (e.g., a home sub-group and a work sub-group) that have additional limitations. If a prospective human or AI member or guest of the SNET group participates in an external SNET, database information maintained by the SNET hosting system 201 might be used to extend an invitation. Other elements may be added in a like manner.

In some embodiments, the content of various database elements (e.g., 221b-225b and 211c-215c) may be updated as necessary or on a scheduled basis using push/pull requests. In order to support inter-SNET operations, including the transfer of content between members or guests of different SNETs, database content might be pushed between SNETs directly, or through external constituents and unaffiliated devices, proxy or filter elements, multiple nodes, etc. Security elements may also be employed during such functional interactions. An authorized member may be able to establish limitations content that is allowed in a given database.

FIG. 3 illustrates an exemplary service provider SNET hosting system 311 in accordance with an embodiment of the disclosure. Other service providers may utilize similar SNET hosting systems to support formation of SNET groups and interaction with the illustrated SNET hosting system 311. The illustrated embodiment generally corresponds to the SNET hosting systems of the previous Figure.

More particularly, databases and resources supported by the SNET hosting system 311 include information, content and software applications, as well as associated location and access information 321 that is comprised of profile data 331, media content 333, writings and postings 335, contacts information 337, and remote counterparts 339 thereof. Registered social devices and associated configurations, location and access information 323 may include information relating to peripherals 341, computers 342, phone equipment 343, appliances 344, media equipment 345, and other equipment 346. A member of the SNET hosting system 311 might participate in a variety of SNET groups/circles 325 (each having unique handles). Such SNET groups might include, without limitation, an intra-SNET group(s) 351, a hobbyist group 353, a business group 355, a friends group 357, and a family group 359.

In addition, mapping and access management 327 is provided to support intra- and inter-SNET operations, as well as operations involving non-affiliates. Mapping of SNET functionality and resources, as well as access rights, can be applied at various levels, including per group 361, per human 363, per device 365 and per application 369. The illustrated SNET hosting system 311 further supports browser and application (downloaded or pre-installed) based interface services 329 to support, for example, coexistence between members of different SNET groups. Differing interfaces may be supported for human members 371, inter-SNET human participants 372, social device members 373, inter-SNET device participants 374, social or non-social content hosts 375 and service hosts 376. Such interfaces may operate, for example, on one or more social devices, guest devices, etc. Corresponding non-member counterparts 381, 383, 385, 387, and 389 are maintained for elements 321, 323, 325, 327 and 329 (including sub-elements), respectively. As will be appreciated, various elements of FIG. 3 may change over time as new members are added and new relationships and functional associations are established with other SNETs, SNET members, visitors and guests.

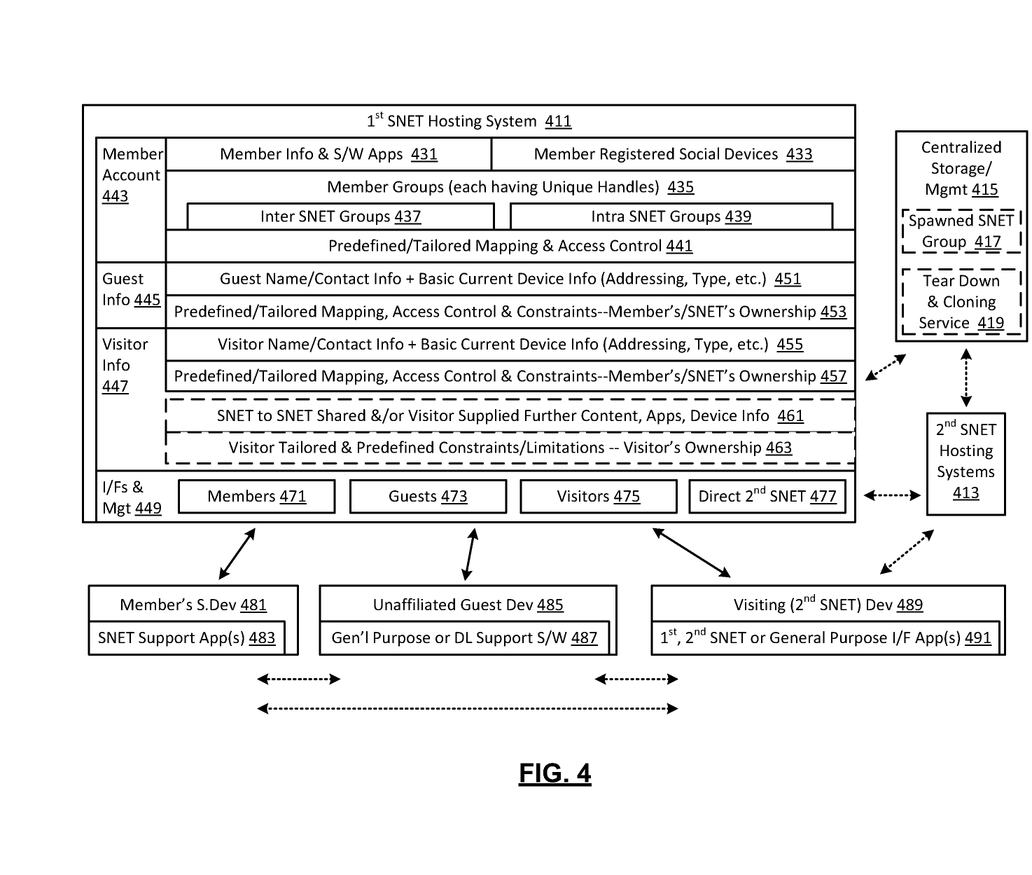

FIG. 4 illustrates, among other things, social network group spawning and dismantling in accordance with an embodiment of the disclosure. In this embodiment, a first SNET hosting system 411 establishes or maintains a member account 443 reflecting a member's profile information and software applications 431 and registered social devices 433. The member account 443 further indicates SNET groups 435 (including inter-SNET groups 437 and intra-SNET groups 439) in which the member participates, each of which may have a unique identification handle. As with previously described embodiments, predefined/tailored mapping and access control functionality 441 is provided to facilitate functional interactions between members of different SNETs and SNET groups, etc.

For a guest wishing to interact with a SNET member, guest information 445 is maintained, including name and contact information, and basic current device information for one or more devices associated with the guest, such as device address information, type, etc. (element 451). Predefined or tailored mapping, access control and constraints 455 are also provided, and may be administered by a SNET or SNET member. Likewise, visitor information 447 is maintained by the SNET hosting system 411, including name and contact information, and basic current device information such as device address information, type, etc. (element 455). Predefined or tailored mapping, access control and constraints 457 are also provided, and may be administered by a SNET or SNET member. In addition, SNET to SNET shared and/or visitor supplied content, applications and device information 461 may be maintained by the SNET hosting system 411. In certain embodiments, a visitor may own and control tailored and predefined constraints and limitations (element 463) on visitor information 447.

Various interfaces and management functionality 449 is also provided to facilitate interactions with members and resources of the SNET hosting system 411. More particularly, tailored interfaces 471, 473, 475 and 477 are illustrated for interactions with member's social devices 481, unaffiliated guest devices 485, visiting (e.g., from a second SNET) devices 489, and second SNET hosting systems 413, respectively. In this embodiment, the member's social devices 481 include SNET support applications 483. The unaffiliated guest devices 485 include general purpose or downloaded support software 487, and the visiting devices 489 included first and second SNET or general purpose interface applications 491. In some embodiments of the disclosure described herein, a user interface may comprise a graphical user interface (GUI), voice controls, gesture commands, etc. The user interface may take the form, for example, of a browser that graphically indicates available operations spanning more than one SNET and in furtherance of various bridging, mapping and access control operations.

In the illustrated embodiment, centralized storage and management 415 may be utilized to support or manage interaction between members of the first SNET hosting system 411 and second SNET hosting system 413. Such interactions might include, for example, the transfer and storage of profile information associated with one or more human/device members of a SNET group, as well as security operations relating thereto. Further, the centralized storage and management 415 may be utilized to host or create a “spawned” SNET group 417 that supports coexistence and interaction between 1) membership of an existing SNET group and 2) all or a subset of membership of a second existing SNET group. The spawned SNET group 417 may include a subset of the functionality existing in one or more existing SNET groups as determined by an automated or user-directed mapping process. In one alternate embodiment, a spawned SNET group 417 supports interaction between membership of an existing group and non-member/unaffiliated guest social devices. Following creation of the new SNET group, one or more of the pre-existing SNET groups may be dismantled as contextually appropriate by a tear down and cloning service 419. The tear down and cloning service 419 might also function to clone all or portions of account and profile information associated with a SNET member. Further, a spawned SNET group 417 may be tailored for specific applications and ease of maintenance. In addition, the spawned SNET group 417 may be hosted in centralized infrastructure that is selected on the basis of equipment costs, power considerations, available communication resources, etc.

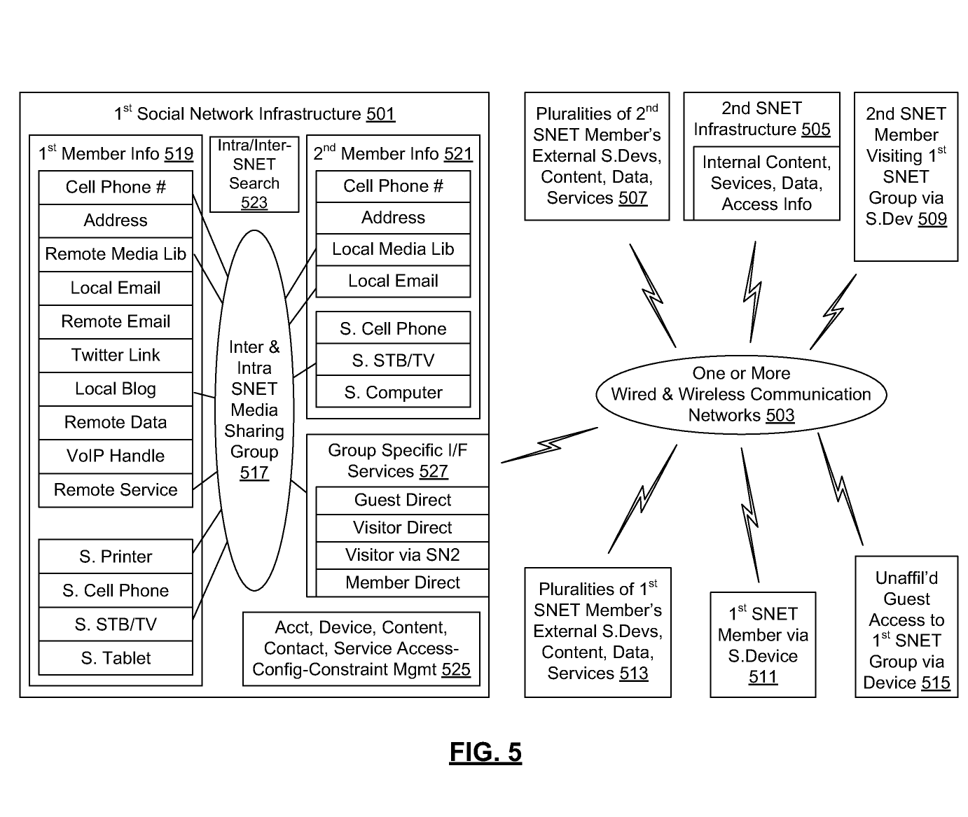

As described above in conjunction with FIG. 1 and elsewhere, various embodiments of a SNET group according to the disclosure may comprise a wide variety of social devices, device services, proxies, and software applications of various types participating as SNET group members. Further, social devices and other types of SNET group members having related or specific characteristics and interdependencies may form SNET groups having specific purposes such as those described below in conjunction with FIG. 5. Various embodiments may comprise, for example, SNET/group members such as device manufacturers, automobile owners, hospitals and medical providers, repair shops, insurance companies and other third parties that might have an interest in communicating with a human member and/or associated SNET devices. Such SNETs/SNET groups may be stand-alone or an extension of other SNETs/SNET groups.

In the embodiment of FIG. 5, an inter- and intra-SNET media sharing group 517 hosted by a first SNET infrastructure 501 is illustrated. The media sharing group 517 may be configured to permit sharing of and access to, for example, first member information 519 and second member information 521. Exemplary first member information 519 includes, without limitation, contact information such as a cell phone number or address, a remote media library, local and remote email service and addresses, a Twitter link, a local blog, remote data, a VoIP handle, one or more remote services, as well as information enabling access to a selection of docked or undocked social devices (such as a social printer, cell phone, set-top box, television, tablet, etc.). Similarly, second member information 521 includes, without limitation, a cell phone number and address, local media library, local email, and information enabling access to a selection of social devices (such as a social cell phone, set-top box, computer, etc.).

Intra-/inter-SNET search functionality 523 can be provided to identity prospective SNET group participants (or resources), which may be treated differently depending on whether the participants are “friendly” secondaries, independent or partially independent, located nearby, authorized to participate or have preexisting associations with the group, etc. Such search functionality may be supported by a SNET hosting infrastructure and/or provided by external entities.

The SNET infrastructure further includes access, configuration and constraint management functionality 525 for accounts, devices, content, contacts, and services access. In general, a member of a SNET in accordance with various embodiments of the disclosure may establish permissions and/or privacy settings that control and restrict who or what may access the member's profile(s) information, offer services, communication resources, connections and groups, as well as define desired degrees of access. Permissions may enable the user to maintain certain resources or information as private or available on a permissive basis only. For example, accessibility to available communication resources or social content may be limited to users/devices in a particular SNET or SNET group. Alternatively, such resources may be publicly available. Likewise, a SNET member may selectively decide to permit others to access personal information such as name, gender, contact information/email address, etc. Profiling information for a SNET group and group members may be updated on a continual or periodic basis as necessary to support desired functionality.

External interaction with the SNET infrastructure 501 may occur via group specific interface services 527, including services that permit direct interaction with members, guests and visitors, and/or interactions via a second SNET. Various entities may access the SNET infrastructure 501 over one or more wired and wireless communication networks 503, which might include an adaptive or parallel network communication/routing infrastructure involving a wide variety of communication protocols and wired and/or wireless communications channels, including over an Internet backbone, cellular communication system, WAN, LAN, etc. In the illustrated embodiment, the media sharing group 517 may be accessed by: a second SNET infrastructure 505 (including internal content, services, data, access information, etc.); pluralities of a second SNET member's external social devices, content, data, and services 507; a second SNET member visiting the first SNET group/infrastructure via a social device 509; a first SNET member via a social device 511; pluralities of first SNET member's external social devices, content, data, and services 513; and unaffiliated guest access to the first SNET group/infrastructure via a device 515.

It is noted that numerous of the functional building blocks of the embodiments of the disclosure illustrated in the foregoing Figures may be incorporated, in whole or part, in one or more (application specific) integrated circuit devices. For example, an integrated circuit device may include a member reporting module to provide member reporting functionality (including communication of device status and device characteristics), device feature mapping and control capabilities, security and access control modules, etc. Such an integrated circuit device may also include onboard processing capabilities and/or interface with a processor device. Alternatively, several of the functions described above may be incorporated, in whole or part, into an operating system and/or software loaded above an operating system kernel.

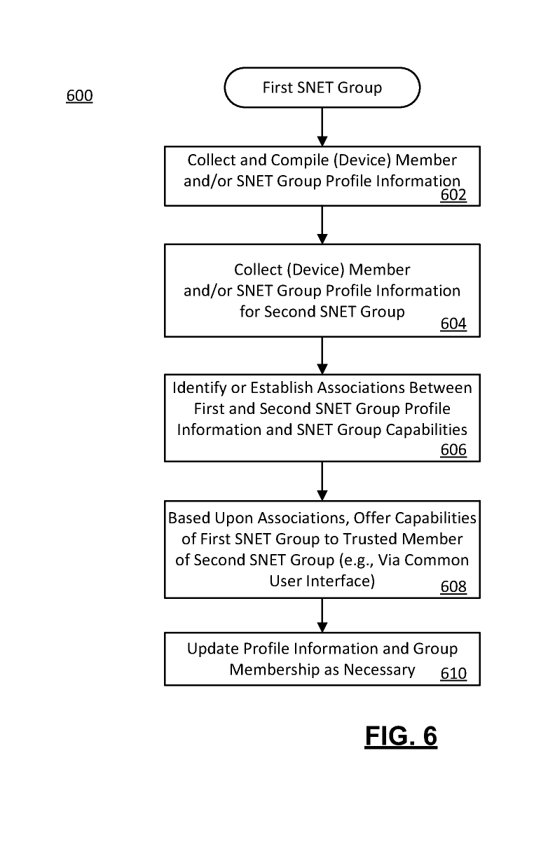

FIG. 6 is a logic diagram of a method 600 for extending capabilities of first social network group to a member of a second social network in accordance with an embodiment of the present disclosure. In initial steps 602 and 604, profile information associated with first and second SNET groups, and/or one or more members thereof, is collected and compile for use in mapping-like operations and establishing desired interactions.

Profile information associated with a social device may enable the device to present an image of itself and its capabilities and configuration to other members of a SNET group. Depending on the current capabilities and requirements of a particular device (and other members of a SNET), such device profiles may be static or dynamic. As discussed above, profile information associated with a human member may convey a wide range of information, including contact information or a handle associated with one or more human members, current or desired group memberships, etc. Such profiling information might also be used, for example, to generate introductions with people of similar interests (dating, friends and contacts, hobbies and sports, gaming activities using like platforms/software, professions, device ownership, etc.). If desired, offers to interact with a particular SNET group could be generated or accepted on an anonymous basis.

Next, in step 606, functional associations are identified or established between SNET members or groups using the information collected in previous steps. In various embodiments, such associations may be created automatically or through a selective process that might involve, for example, a human member specifying specific capabilities for inclusion in the functional associations. As shown in step 608 of the illustrated embodiment, the functional associations are utilized to offer capabilities of a first SNET group to one or more members of a second SNET group. A common user interface may be employed to support interactions involving the offered capabilities. It is contemplated that profiling information for a SNET group and/or group members may be updated (step 610) on a continual or periodic basis as necessary to support desired operations.

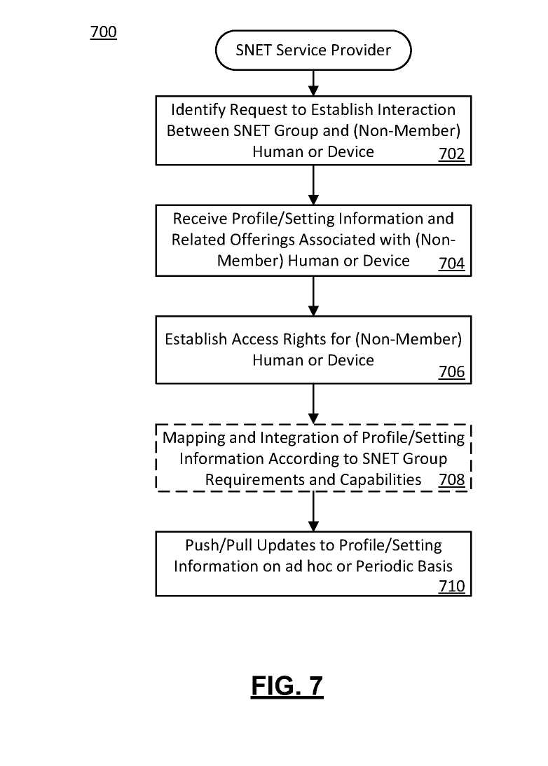

FIG. 7 is a logic diagram of a method 700 for establishing associations between a social network group and a human or social device having established profile information in accordance with an embodiment of the disclosure. The method might be performed, for example, by a social networking service provider or a SNET hosting infrastructure following receipt of a request (step 702) by a non-member human user or device to establish interaction. Subsequently (or in conjunction with the request), in step 704 a SNET management service, profiling module or like functionality receives profile/setting information and an indication of related offerings associated with the non-member human or device. With respect to a human non-member, information that may be compiled includes, but is not limited to, a list of associated social devices and device capabilities, location and contact information, social networking membership affiliations and history, an identification handle, etc. In certain situations, the non-member may selectively enable copying or transfer of such profiling information via self-promotion or in response to a request, such that the information does not need to be generated or re-created by a social networking service provider.

Next, in step 706, access rights to SNET group resources and participants are established for the non-member human or device. Mapping and integration of profile/setting information of the non-member human or device may also occur in step 708 in accordance with the established access rights, as well as SNET group requirements and capabilities. Such mapping and integration may support interaction between, for example, a device(s) associated with a member of the SNET group and a device associated with a non-member human. The profile/setting information provided in step 704 may be updated on an ad hoc or periodic basis as shown in step 710. Such updates may be initiated or performed by the non-member human or device, or by one or more nodes of the SNET group.

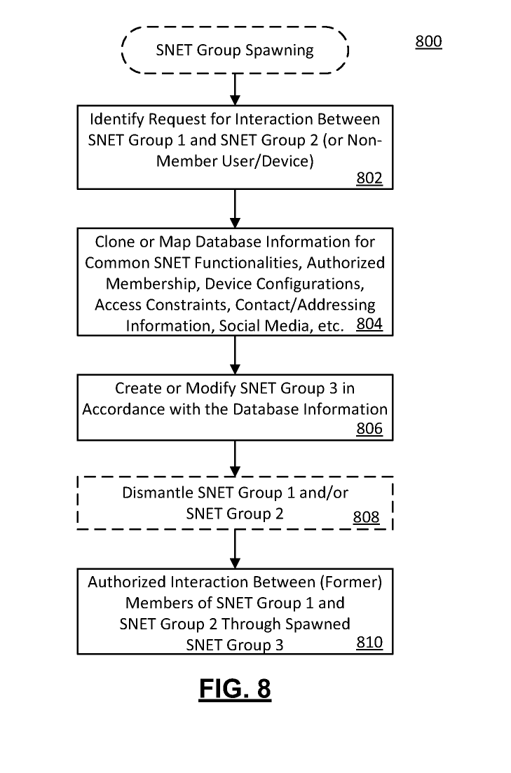

FIG. 8 is a logic diagram of a method 800 for spawning social network group in accordance with an embodiment of the present disclosure. As discussed above in conjunction with FIG. 4, spawning of a new SNET group can support coexistence and interaction between 1) membership of an existing group and 2) all or a subset of membership of a second existing group. The “spawned” SNET may include a subset of the functionality existing in one or more existing SNET groups, and may be hosted in centralized infrastructure.

In the illustrated embodiment, the method commences in step 802 following identification of a request for interaction between a first SNET group and a second SNET group. In alternate embodiments, the interaction may be desired between a first SNET group and a non-member human user or social device. Next, in step 804, database information is cloned, mapped or otherwise generated for a common set of desired SNET functionalities, authorized membership, device configurations, access constraints, contact/addressing information, social media, etc. Based on such database information, a new SNET group is created in step 806. Alternatively, a third, preexisting SNET group may be modified to accommodate desired commonalties between the first and second SNET groups. In certain embodiments, one or both of the first and second SNET groups may be dismantled (step 808). In step 810, following the SNET spawning process, authorized interactions between members of the first and second SNET group occur through the newly spawned SNET group.

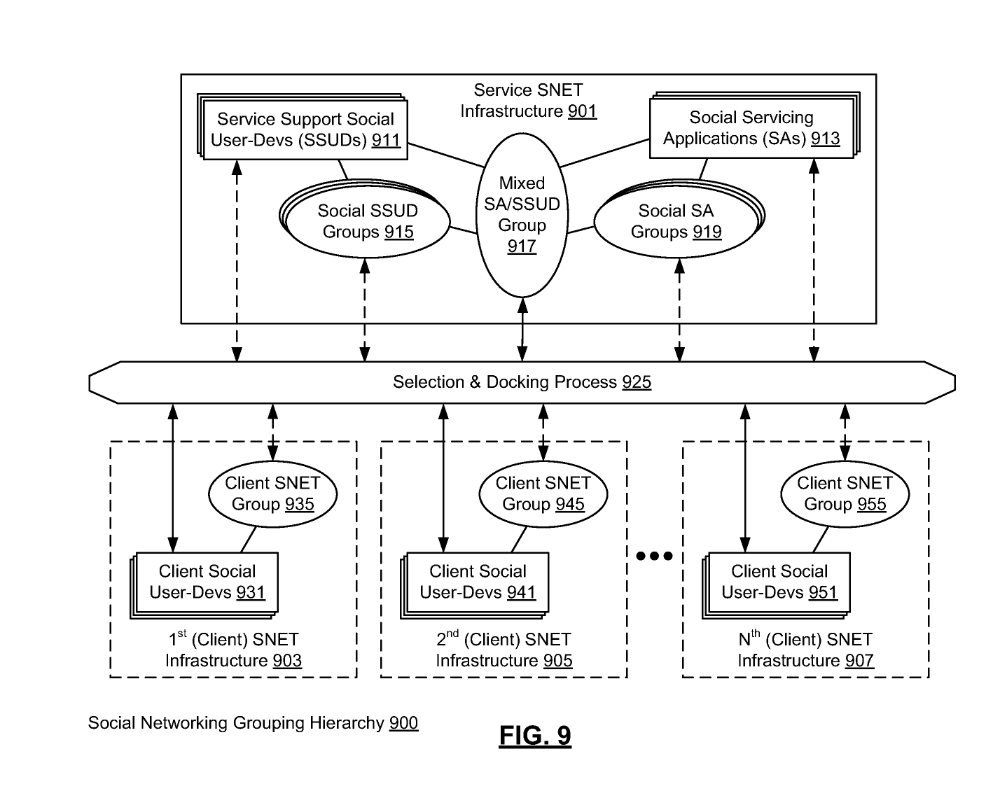

FIG. 9 illustrates a schematic block diagram of a social networking grouping hierarchy 900 according to various embodiments of the disclosure. In some embodiments, a SNET grouping hierarchy 900 includes one or more tiers of SNET infrastructure, encompassed at least in part by a SNET, that can be docked to (hereinafter referred to interchangeably as “associated with”, “joined to”, and the like) other SNET infrastructure, SNET groups, and social devices. For example, in the illustrated embodiment, one tier of SNET grouping hierarchy 900 can include a service SNET infrastructure 901, and another tier of SNET grouping hierarchy 900 can include one or more client SNET infrastructures 903, 905, and 907. In some embodiments, various tiers can be docked such that a “higher” tier can be docked to “lower” tiers to provide access by “lower” tiers to various capabilities provided by the “higher” tier.

In some embodiments, one or more infrastructures are managed by one or more processing systems, computers, server devices, network nodes, social devices/services, or some combination thereof. For example, in the illustrated embodiment, some or all of the service SNET infrastructure 901, one or more client SNET infrastructures 903, 905, and 907, or some combination thereof may be managed by one or more social service support devices 911, one or more client social devices 931, 941, and 951, or some combination thereof. Processing systems can include, without limitation, one or more instances of processing circuitry distributed across one or more server devices or network nodes.

For example, in the illustrated embodiment, SNET grouping hierarchy 900 includes a service SNET infrastructure 901 in a first tier, and multiple client SNET infrastructures 903, 905, and 907 in a second tier. Infrastructures can include, without limitation, one or more SNET groups, one or more support services, applications, resources, devices, and the like associated with one or more entities, which can include, without limitation, clients, members of a SNET, nonmembers of a SNET, guests of a SNET, manufacturer groups, service groups, etc. For example, service SNET infrastructure 901 may include user devices 911, applications 913, and SNET groups 915, 917, and 919 associated with one or more support services or SNET members.

Similarly, a client SNET infrastructure 903 can include one or more client SNET groups 935 and one or more social devices 931 associated with one or more particular clients (e.g., users, members, visitors, and guests). For example, a first client-side infrastructure 903 can include one or more SNET groups 935 associated with a SNET member, along with one or more social devices 931 associated with the SNET member. As shown in the illustrated embodiment, the social devices 931 in a client infrastructure 903 can be docked or otherwise affiliated with SNET groups associated with the client. In some embodiments, a device or SNET group docked to another SNET group becomes a member of the SNET group to which it is docked. By docking a client social device 931 to a client SNET group 935, a user associated with a client SNET group 935 may interact with the SNET group 935 by interacting with a social device 931 docked to the SNET group 935. Members, clients, users, and the like may include, without limitation, human members of a SNET or some other network, device members of a SNET or some other network, certain fixed and intelligent services, some combination thereof, etc.

In some embodiments, one or more capabilities (which might include, for example, various support services, applications, or SNET groups) are mixed, combined, and/or merged via a docking process, into one or more SNET groups that can provide functional associations with and/or access to a desired selection of capabilities through interaction with the one or more SNET groups. For example, service SNET infrastructure 901 illustrates capabilities that can be provided by various service support social user devices 911 and/or various social servicing applications 913. In some embodiments, access to various service support social user devices 911, either directly or through interaction with a SNET group 915 to which the service support social user devices 911 are docked, and access to various social servicing applications 913, either directly or through interaction with a SNET group 919 docked to the social servicing applications 913, can be provided to SNET members.

One or more of the capabilities provided by the devices 911, applications 913, and SNET groups 915 and 919 may be combined into a single SNET group that can provide functional access to one or more capabilities and services provided by devices, applications, SNET groups, or some combination thereof. For example, a user of a client SNET infrastructure 903 can, by docking a social device 931, via a docking process 925 (which may be supported by local or distributed system circuitry), to a single SNET group 917 that itself combines SNET groups 915 and 919, gain access to the capabilities provided by both SNET groups 915 and 919 by docking with SNET group 917.

In some embodiments, functional associations to support services and other capabilities provided by one or more SNET groups/infrastructures can be accomplished by docking one SNET group to another SNET group. For example, a client SNET group 935 can be docked, via a docking process 925, to SNET group 917, thereby enabling a user of the client-side infrastructure 903 to access the capabilities and services provided by SNET group 917 through the client SNET group 935. In particular, where one or more social devices 931 are docked to the client SNET group 935, a user can access the capabilities and services provided by SNET group 917 via one or more of the social devices 931 that are docked with the client SNET group 935. A docking process 925 can include joining client SNET group 935 as a member of SNET group 917, docking (also referred to herein as “associating”) client SNET group 935 to SNET group 917 via one of various processes described herein.

In some embodiments, docking SNET groups such that a user, member, client, or the like can access capabilities provided by various services, devices, and SNET groups associated with various SNET infrastructures enhances security. For example, where a user associated with a first client SNET infrastructure 903 can only access capabilities provided by service SNET infrastructure 901 by docking with SNET group 917, various levels of security can be utilized by one or more processing systems/devices associated with the service SNET infrastructure 901, client SNET infrastructure 903, etc. to ensure secure access to the capabilities.

In addition, in some embodiments, accessing capabilities provided by a SNET infrastructure by docking two or more SNET groups provides additional levels of security. For example, where access to capabilities provided by service SNET infrastructure 901 entails docking a client SNET group 935, 945, 955, or the like to SNET group 917, a more secure connection, with various levels of security, can be employed, and access to the capabilities can be easily granted, altered, restricted, or terminated via management of a single dock or association between a client SNET group and SNET group 917. A processing system/device associated with the service SNET infrastructure 901 or a client SNET infrastructure 903 may manage the association based upon inputs received from a user, a third-party entity, some internal logic, elapse of a period of time, a change in geographic location of a client social device 931 associated with the client SNET infrastructure 903, or some other trigger event.

In some embodiments, the selection and docking process 925 can be automated, and/or automatic. For example, a docking process may be automatic by being triggered based upon a location of a user of an infrastructure, including, without limitation, a geographic proximity of one or more of a user, a social device 931 associated with a user, or a social device 931 docked with a particular client SNET group 935. In some embodiments, a user can provide one or more association rules that can provide conditions under which one or more particular client SNET groups 935 can be docked to other SNET groups. Conditions may include, for example, geographic proximity of one or more social devices 931 docked to the particular client social 935 to a geographic location associated with a SNET group 917, authorization by a user associated with the infrastructure 903, SNET group 935, or social device 931 to dock the client SNET group 935 with SNET group 917. Association rules can be communicated to a social device 931 docked with a particular SNET group 935 or a processing system that manages docking of various SNET groups. A processing system, a social device 931, or some combination thereof can monitor a client SNET group 935, social device 931 docked to the client SNET group 935, one or more attributes of another one or more SNET groups 917 in relation to one or more attributes of one or more client SNET groups 935, docked social devices 931, or the like in relation to one or more association rules in order to determine whether to dock one or more SNET groups and/or social devices/services together. Association rules can be altered by a user or a processing system on the fly to create new rules, delete rules, alter rules, etc. For example, a user associated with a client SNET group 935, who may have previously communicated to a processing system an association rule that prohibits docking the client SNET group 935 to a SNET group 917 beyond a threshold geographic proximity to a social device 931, can communicate, on the fly, an alteration of the association rule that can include, for example, altering the threshold geographic proximity, authorizing a docking of the client SNET group 935 to a particular SNET group 917 on a case-by-case basis, ordering an undocking of a client SNET group 935 from another SNET group, etc.

In some embodiments, various tiers of a SNET grouping hierarchy 900 are subject to various levels of access to information and/or services. For example, in the illustrated embodiment, a user of the “higher-tier” service SNET infrastructure 901 may be able to access or view each client SNET group 935, 945, and 955 associated with a “lower-tier” client SNET infrastructure 903, 905, and 907 that is docked to a SNET group 917 associated with the social service infrastructure 901. A user of the service SNET infrastructure 901 may also be able to view the various social devices 931, 941, and 951 docked to the various client SNET groups 935, 945, and 955. In another example, one or more users of a “lower-tier” infrastructure including, without limitation, client SNET infrastructure 903, 905, and 907 may be able to view some or all of the capabilities provided through a SNET group associated with a “higher-tier” infrastructure to which a SNET group associated with the “lower-tier” infrastructure is docked, but cannot view some or all of the “higher-tier” infrastructure, including, without limitation, various SNET groups 915 and 919 from which capabilities provided by SNET group 917 are originally provided. Additionally, a user of a “lower-tier” infrastructure accessing a SNET group 917 associated with a “higher-tier” service SNET infrastructure 901 may be unable to view some or all of the other similarly “lower-tier” client SNET infrastructures 905 and 907 that are also docked with the same SNET group 917.

In some embodiments, the selection and docking process (or service) 925 can be controlled or managed by one or more various social devices or processing systems. For example, a processing system of a SNET infrastructure, which can include one or more instances of processing circuitry distributed across one or more server devices and/or network nodes may control the docking and undocking of one SNET group to another, based upon a user's interaction with the SNET, one or more association rules, one or more inputs, some internal logic, etc. As another example, a social device may control the docking and undocking of one or more SNET groups based upon a user's interaction with the SNET, one or more association rules, one or more inputs, some internal logic, etc. In some embodiments, a processing system or social device authorized to manage a “higher tier” infrastructure can manage one or more attributes of access by one or more “lower-tier” infrastructures docked to the “higher-tier” infrastructure. For example, a processing system authorized to control a “higher-tier” social service infrastructure 901 may alter access to certain capabilities, restrict access to certain capabilities, and/or terminate access via undocking of SNET groups and devices based upon input or other logic operation. The processing system may determine that a trigger event (e.g., all social devices 931 docked with a client SNET group 935 docked to SNET group 917 have exceeded a predetermined threshold of proximity distance from a geographic location associated with SNET group 917) has occurred and, based upon the determination, undock the client SNET group 935 from SNET group 917, partially or fully restrict access by client SNET group 935 to certain capabilities provided by SNET group 917, etc.

SNET group resources (such as social devices 120 of FIG. 1) may be accessible via a zero configuration, multicast discovery protocol that locates devices and the services offered by those devices on a local network using a multicast discovery protocol and related service records or profiling information. Such a protocol may operate at the application layer, and transmissions of configuration/capability information can be used, for example, to identify and utilize common programming interfaces, protocols, packet formats, and the like between two or more devices, bridging nodes, proxy nodes, etc. Wide area service discovery of SNET group resources configured in this manner may be enabled through an appropriately configured domain name service (DNS) server. Further, SNET group resources may be configured to support interoperability guidelines and network protocols (such as UPnP) that provide uniform mechanisms and restrictions for accessing resources and data over a network.

In other embodiments according to the disclosure, membership in a SNET group may be established through a docking process that utilizes one or more device discovery and configuration protocols. When group membership is restricted, a local or cloud-based registrar can also be employed to provide authentication. The registrar may utilize an administrator, or a directory service such as a Lightweight Directory Access Protocol (LDAP)-based directory server that stores attribute data. When docking with an IP-based SNET group, a social device might broadcast profile data to the local domain using a textual data format such as Extensible Markup Language (XML). In further illustrative embodiments, a network configuration protocol might be utilized (e.g., by a gateway device), such as the Dynamic Host Configuration Protocol (DHCP) and related standards, promulgated and maintained by the Internet Engineering Task Force (IETF), or similar protocol that automates network-parameter assignment to network aware social devices. In addition to minimizing the need for manual device configuration, DHCP provides a central database of devices that are connected to a network and eliminates duplicate resource assignments.

Referring now to FIG. 10, a schematic block diagram is shown for an embodiment of a social device comprising integral functionality operable to support social network group/sub-group memberships and communications in accordance with the disclosure. In the illustrated embodiment, a communication interface and transceiver circuitry 1002 is operable to perform wired or wireless communications between the social device 1000 and a SNET group(s)/sub-group(s) 1026 over one or more communication channels. Depending on the capabilities and configuration of the social device 1000, communications with a SNET may be unilateral or bidirectional/interactive, and utilize either a proprietary or standardized communication protocol. Communications may include, for example, device profile information, user and SNET group profile information, servicing information, control signals, audio/video content, interactions with hosted service data, user data, relayed information, etc.

The social device 1000 further includes processing circuitry 1004 operable to process and manage communications, services and associations between the device and other entities including members of a SNET group/sub-group 1026, third parties, software agents, etc. More particularly, the processing circuitry 1004 may include, for example, a software management application 1012 comprising one or more of docking logic 1014 (including support for device discovery and configuration protocols such as described below), communication protocol control 1016, service and resource management 1018, and security/authentication 1020 functionality.

The social device 1000 further may utilize that may take many forms and be maintained in static or dynamic memory 1024. Such profile information enables a social device and/or user to present an image of itself and its capabilities to other members of a SNET. In particular, device/group profile information and other resources 1006 and user profile information 1008 may be utilized in various ways in accordance with the disclosure to facilitate a variety of social interactions. Depending on the capabilities and requirements of a particular device (and other members of a SNET), a device or user profile may be static or dynamic.

In certain embodiments, the social device 1000 may interact with a user(s) via user interface circuitry 1010. User input to the social device 1000 may include, for example, data entry through a keypad, touchscreen, remote control device, gaming controller, device control buttons, voice or gesture commands, storage device, etc. For example, voice or gesture commands may be utilized to trigger membership services such as those described above. Authorized access to or control of the social device 1000 can be facilitated through unique biometric identifiers, passwords, token-based identification, trusted authorities or documents such as a driver's license or passport, and like authentication means.

The social device 1000 may perform core or underlying functionality 1020 (e.g., a social appliance, security device, vehicular communication node, etc.). Alternatively, the social device may primarily function as a social networking interface or communication device, or be programmable to perform specific functions within a SNET group/sub-group. Further, a social device 1000 may operate in a social device “hierarchy” comprising social devices, social “parent” devices and social “child” devices. Briefly, social parent devices may enable associated child devices to interact and/or connect with a social network, either directly or indirectly. For example, social capabilities and profiling information associated with a child device can be provided via a parent device. Dynamic and hierarchical associations between parent and child devices may be established in a selective, automatic or automated manner. Further, a human SNET member might have associated social child devices, or be served by a social parent device via a user I/O interface.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A social network hosting infrastructure that supports a first social networking group having associated capabilities available to at least a first member, the social network infrastructure further supporting interaction with a second social networking group having a membership that includes at least a second member, comprising:
a management service that supports communications with the second social networking group, the communications including exchange of profile information associated with the second member; and
a mapping and access service that establishes functional associations with capabilities of the first social networking group based on the profile information associated with the second member.

2. The social network hosting infrastructure of claim 1, further comprising:
an interfacing service operable with the mapping and access service to support interaction between the first member and the second member, the interaction delimited at least in part by an association established by the mapping and access service.

3. The social network hosting infrastructure of claim 2, wherein the interfacing service supports a browser-based human input/output interface for use by the first member and the second member.

4. The social network hosting infrastructure of claim 1, the mapping and access management service further supporting the first member in selectively specifying capabilities of the first social networking group for inclusion in the functional associations.

5. The social network hosting infrastructure of claim 1, the second member is a social capable device, wherein the profile information comprises device configuration information.

6. The social network hosting infrastructure of claim 1, the profiling information comprising an identity handle associated with a human.

7. The social network hosting infrastructure of claim 6, the mapping and access service, upon receiving the identity handle, further docks at least one device associated with the human to the first social networking group.

8. A method performed by a social network service provider, the method comprising:
maintaining a first social networking group through which first group services are available to at least a one member of the group;
receiving profile information associated with a member of a second social networking group;
based on the profile information, determining functional associations between the first group services and the second social networking group; and
enabling the availability of at least one of the first group services for access by the member of the second social networking group in accordance with the functional associations.

9. The method of claim 8, further comprising:
providing a common user interface to support interactions between the member of the first social networking group and the member of second social networking group.

10. The method of claim 8, the profiling information comprising an identity handle associated with a human member of the second social networking group.

11. The method of claim 10, wherein enabling the availability of at least one of the first group services further comprises docking a social device associated with the identity handle to the first social networking group.

12. The method of claim 11, further comprising:
configuring a common user interface to support interactions between the first social networking group and the second social networking group based on the functional associations, the common user interface hosted by the social device.

13. The method of claim 8, the profile information stored in a database maintained by the first social networking group, further comprising:
updating the profile information on a real time basis.

14. The method of claim 8, the second social networking group offering second group services, further comprising:
enabling the availability of at least one of the second group services for access by the member of the first social networking group.

15. A method for interacting with devices supporting human members of a social networking group, comprising:
maintaining member profile information for the human member, the member profile information providing an indication of devices affiliated with the human member and accessible via the social networking group;
receiving profile information associated with the second, non-member device;
establishing access rights for the second, non-member device based at least in part on the associated profile information; and
supporting interaction between the first device and the second, non-member device in accordance with the access rights.

16. The method of claim 15, further comprising:
identifying a request for interaction between a first device affiliated with the human member and a second, non-member device, wherein receiving profile information associated with the second, non-member device occurs in response to identifying the request for interaction.

17. The method of claim 15, the profile information associated with the second, non-member device comprises profile information for a human guest member of the social networking group.

18. The method of claim 15, the profile information associated with the second, non-member device comprises an identity handle associated with a human member of a second social networking group.

19. The method of claim 15, wherein supporting interaction between the first device and the second, non-member device comprises providing a common user interface.

20. The method of claim 19, the common user interface hosted by the second, non-member device.
